(19) United States
(12) Patent Application Publication
(10) Pub. No.: US 2006/0078315 A1
(43) Pub. Date: Apr. 13, 2006

(54) Image display device, image display program, and computer-readable recording media storing image display program

(76) Inventors: Toshiaki Wada, Tokyo (JP); Yoshiyuki Fukuya, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/222,246

(22) Filed: Sep. 8, 2005

(30) Foreign Application Priority Data
Sep. 13, 2004 (JP) P2004-266115
Aug. 12, 2005 (JP) P2005-234272

(51) Int. Cl. H04N 5/76; H04N 5/225

(52) U.S. Cl. 386/117

(57) ABSTRACT

An image display device of this invention has a display screen provided with a first thumbnail area, and second and third sub-thumbnail areas. Thumbnail images of images belonging to a group distant by a prescribed time period from the group displayed in the first thumbnail area are randomly extracted and displayed in the second and third sub-thumbnail areas. For example, when arranged by year of image capture, images of one year before and one year after the images displayed in the first thumbnail area are extracted at random and displayed in the second and third sub-thumbnail areas, respectively. In addition to images resulting from a search specified by the user, by also displaying on the same screen images not anticipated by the user, the user is presented with chance encounters with images.

### BACKGROUND OF THE INVENTION

1. Field of the Invention

This invention relates to an image display device, image display program, and recording media storing an image display program, which are suitable for use in managing image files captured by a digital camera.

Priority is claimed on Japanese Patent Application No. 2004-266115, filed on Sep. 13, 2004, and Japanese Patent Application No. 2005-234272, filed on Aug. 12, 2005, the entire contents of which are incorporated herein by reference.

2. Description of the Related Art

Image data captured by a digital camera or similar is often transferred to the personal computer of a user for management. When image data captured by a digital camera is transferred to the personal computer of a user, numerous image data sets can be managed all at once. Moreover, image editing can be performed easily on a personal computer. Further, image data stored on a personal computer can be copied to a CD-R (Compact Disc Recordable) or other optical disc, and stored over a long period of time. Furthermore, when a hard copy is necessary, images can be printed by a printer connected to the personal computer.

When managing image data captured by a digital camera on a personal computer, files are displayed in a folder tree of a hierarchical file system, and ordinarily a method is employed in which searches for target files are performed while moving through the folder tree of the hierarchical file system. However, increases in the capacity of the storage devices of personal computers in recent years have resulted in vast numbers of image files being stored on personal computers. As the number of image files stored on a personal computer becomes huge, it becomes difficult to effectively search for a desired image file using a folder tree of such a hierarchical file system.

Hence methods have appeared in which, by using reduced-size images called “thumbnail” images, it has become possible to visually manage image files. Further, methods have appeared, such as for example that described in U.S. Patent Application, Publication No. 2004/0125150, in which a calendar is displayed, and thumbnails of images captured on each day are displayed on the calendar.

However, when searches for image files are performed, during the search a user may happen upon images which are especially nostalgic, eliciting memories of the period, and exciting a desire to see related images. This is an experience similar to that of happening upon nostalgic photographs while organizing an old photo album.

### SUMMARY OF THE INVENTION

An object of this invention is to provide an image display device, image display program, and computer-readable recording media storing an image display program, which, by causing to be displayed on the same monitor images not contemplated by the user in addition to images which are the results of a search specified by the user, presenting the user with chance encounters with images, and inducing retrospection and a desire to use the images.

A display device displaying a plurality of images of this invention has a classification unit which classifies a plurality of images into a plurality of groups by period based on date information accompanying each image; a group selection unit which selects one group classified by the classification unit corresponding to a date specified by the user; a screen division unit which divides the display screen into a plurality of display areas; a first display unit which displays index images of images belonging to a first group selected by the group selection unit in a first display area of the screen divided by the screen division unit; and a second display unit which displays index images of images belonging to one or a plurality of second groups different from the first group in one or a plurality of respective second display areas different from the first display area.

An image display program displaying a plurality of images of this invention has a classification step of classifying a plurality of images into a plurality of groups by period based on date information accompanying each image; a group selection step of selecting one group classified in the classification step corresponding to a date specified by the user; a screen division step of dividing the display screen into a plurality of display areas; a first display step of displaying index images of images belonging to a first group selected in the group selection step in a first display area of the screen divided in the screen division step; and a second display step of displaying index images of images belonging to one or a plurality of second groups different from the first group in one or a plurality of respective second display areas different from the first display area.

Computer-readable recording media of this invention stores a display program which displays a plurality of images, having a classification step of classifying a plurality of images into a plurality of groups by period based on date information accompanying each image; a group selection step of selecting one group classified in the classification step corresponding to a date specified by the user; a screen division step of dividing the display screen into a plurality of display areas; a first display step of displaying index images of images belonging to a first group selected in the group selection step in a first display area of the screen divided in the screen division step; and a second display step of displaying index images of images belonging to one or a plurality of second groups different from the first group in one or a plurality of respective second display areas different from the first display area.

### BRIEF DESCRIPTION OF THE DRAWINGS

FIG. 1 is a block diagram showing an embodiment of a data management system to which the invention is applied;

FIG. 2 is a block diagram showing an example of the digital camera in the data management system shown in FIG. 1;

FIG. 3 is a block diagram showing an example of the data management device in the data management system shown in FIG. 1;

FIG. 4 is a plane view showing the screen configuration in yearly display mode in one embodiment of the invention;

FIG. 5 is a plane view showing the screen configuration in yearly calendar display mode in one embodiment of the invention;

FIG. 6 is a plane view showing the screen configuration in monthly display mode in one embodiment of the invention;

FIG. 7 is a plane view showing the screen configuration in daily display mode in one embodiment of the invention;

FIG. 8 is a plane view showing an updated screen when thumbnail images of a sub-thumbnail area are selected in one embodiment of the invention;

FIG. 9A through FIG. 9C are plane views of updating of images in a thumbnail area in one embodiment of the invention;

FIG. 10 is a functional block diagram showing operation to form images in a thumbnail area in one embodiment of the invention;

FIG. 11 shows an information management database in one embodiment of the invention;

FIG. 12 is a flowchart showing operation to display a thumbnail area in one embodiment of the invention;

FIG. 13 is a flowchart showing operation to display a thumbnail area in one embodiment of the invention;

FIG. 14 is a flowchart showing operation to substitute images in a thumbnail area in one embodiment of the invention;

FIG. 15 is a flowchart showing operation to substitute images in a thumbnail area in one embodiment of the invention; and,

FIG. 16 is a plane view showing the screen configuration in monthly calendar display mode in one embodiment of the invention.

### DESCRIPTION OF THE PREFERRED EMBODIMENTS

Below, embodiments of the invention are explained referring to the drawings. This invention is suitable for use in managing image data captured using a digital camera or similar.

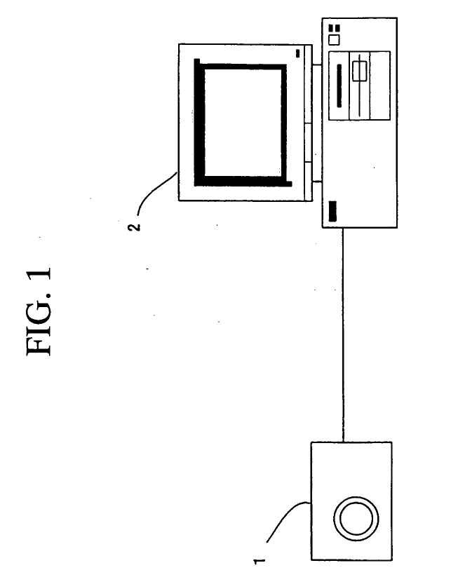

FIG. 1 shows the configuration of a data management system to which this invention can be applied. In FIG. 1, the data management system includes a digital camera 1, and a data management device 2. The data management device 2 is a personal computer, on which is installed an information management program of this invention.

This information management program is provided on portable computer-readable recording media, such as a flexible disk, magneto-optical disc, ROM, or CD-ROM. This information management program may also be transmitted to another computer system from the computer system either via transmission media, or via transmission waves in a transmission medium. A “transmission medium” through which the program is transmitted is a medium having functions for information transmission such as the Internet or another (communication) network, or telephone circuits or other communication circuits (communication lines). Further, a source program may be a program which realizes only a portion of the above-described functions. Also, the program may be a so-called differential file (differential program), realized in combination with a program which stores above-described functions on a computer system in advance.

A memory card is installed in the digital camera 1, and this memory card stores image data captured by a user. When image data captured by the digital camera 1 is transferred to the data management device 2, the digital camera 1 and data management device 2 are connected using, for example, a USB (Universal Serial Bus) interface.

The method used to transfer the image data of the digital camera 1 to the data management device 2 is not limited to a USB interface. Interfaces such as IEEE (Institute of Electrical and Electronics Engineers) 1394, and UART (Universal Asynchronous Receiver-Transmitter), may also be used. And, in addition to such wire interfaces, wireless connection means such as BlueTooth (IEEE 802.15) (a registered trademark) may also be used. In addition, a drive capable of writing to and reading from memory cards may be provided in the data management device 2, so that by removing the memory card from the digital camera 1 and installing the memory card in the drive of the data management device 2, image data stored in the memory card can be read directly by the data management device 2. Further, image data captured by the digital camera 1 can also be transferred over the Internet to the data management device 2.

Image data transferred in such ways from the digital camera 1 is stored, as image files, in a storage device of the data management device 2. In the image files transferred from the digital camera 1 to the data management device 2 are recorded, as supplementary information, the date of image capture, time of image capture, place of image capture, data type, camera model, shutter speed, aperture, focal length, image size, ISO sensitivity, and similar. That is, Exif (Exchangeable image file format) format files are for example used as the image files from the digital camera 1. In the Exif format, such types of information can be recorded as supplementary information. When image data is transferred from the digital camera 1 to the data management device 2, an information management database is created based on such supplementary information.

When performing management of image files stored in the data management device 2, the information management program installed in the data management device 2 is started. As explained below, when performing a search of image files in the data management device 2 in the information management program to which this invention is applied, the image files are classified based on date of image capture, and grouped by “year”, “month” and “day”. Also, a list of thumbnail images of image files belonging to a selected group is displayed. Thus by specifying a date of image capture and displaying thumbnail images, a search for desired image files can be performed.

In an information management program to which this invention is applied, together with the list of thumbnail images to be searched by the user, thumbnail images of image files removed by a prescribed period are also displayed. For example, when searching for “2003” images, thumbnail images for “2002”, and thumbnail images for “2004”, are displayed. As a result, the user, while searching for desired image files, can also encounter nostalgic images. This is described in more detail below.

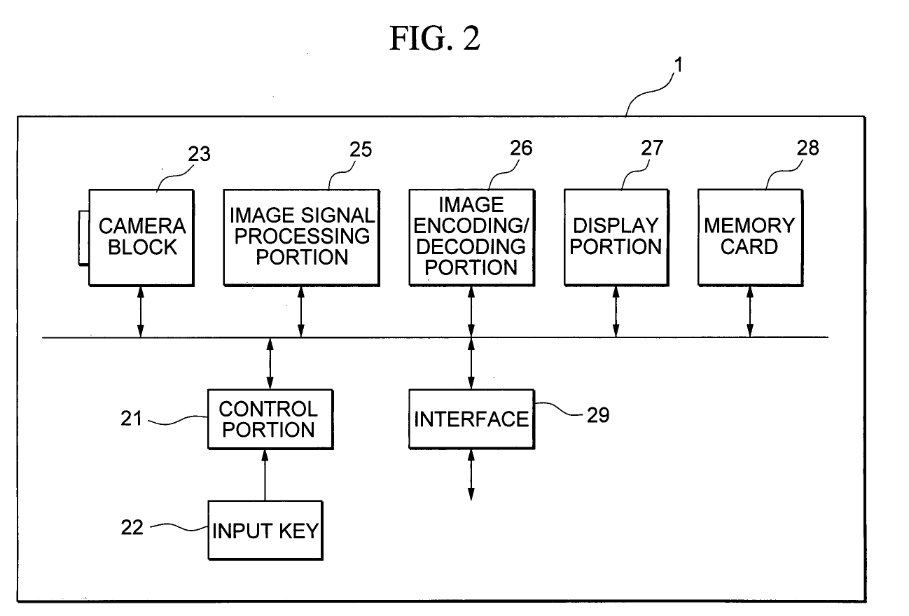

FIG. 2 shows the configuration of one example of a digital camera 1. In FIG. 2, the control portion 21 executes control over the entire digital camera. The control portion 21 is provided with input keys 22. The input keys 22 accept input from a user, and include a shutter key and a key to set the mode of operation.

The camera block 23 has a lens portion, image capture element, iris, signal processing circuit (digital signal processor), and similar. The lens portion focuses image light from the object on the light-receiving surface of the image capture element. Although not shown, the lens portion has an auto-focus mechanism and an optical zoom mechanism. The image capture element performs photoelectric conversion of the object image light focused on the light-receiving surface. As the image capture element, a CCD (Charge Coupled Device) image capture element, or a CMOS (Complementary MOS) image capture element, is used. A color filter is placed in front of the image capture element. As the color filter array configuration, primary color filter with R (red), G (green) and B (blue), or a filter with the complementary colors of Cy (cyan), Mg (magenta) and Ye (yellow), may be used.

Output from the image capture element is supplied to the signal processing circuit, and based on the object image light focused on the light-receiving surface, the signal processing circuit forms color image signals in the three primary colors. These color image signals are sent to other components over the bus 24.

The image signal processing portion 25 performs white balance correction, gamma correction, outline enhancement, and other image processing. In addition, the image signal processing portion 25 performs processing for conversion into the desired resolution.

The image encoding/decoding portion 26 is hardware which performs processing to compress and encode image data from the camera block 23, and to expand image data which has been compressed and encoded, and is connected to the bus 24. As the method of compression of still image data, for example, the JPEG (Joint Photographic Experts Group) standard is used. JPEG is a standard for image compression using discrete cosine transforms.

The image encoding/decoding portion 26 may perform video processing as well as still image processing. As the method of compression of video, the MPEG (Moving Picture Coding Experts Group) standard is used. Of course, methods to compress still images and video are not limited to the JPEG and MPEG methods.

The display portion 27 is, at the time of image capture, an electronic viewfinder or similar, and at the time of playback, is used to monitor captured images. As the display portion 27, for example, a LCD (Liquid Crystal Display) or similar is used.

The memory card 28 is used to store captured images. The memory card 28 is card-type memory which uses flash memory. Instead of using an insertable/removable memory card 28, flash memory built into the camera can be used to store captured images.

The interface 29 is used for connection of the camera to various external devices. The interface 29 is for example used for connection to a data management device 2 consisting of a personal computer, to transfer images captured by the camera to the data management device 2. As the interface 29, for example, a USB interface is used.

At the time of image capture, object image light is photoelectrically converted by the image capture element of the camera block 23, and the result is digitized. Image data from the camera block 23 is sent to the image signal processing portion 25, at which image signal processing is performed. In addition, images being captured are output to the display portion 27; the display portion 27 serves as an electronic viewfinder.

The user sets the camera direction while viewing the display portion 27, and when an image to be captured is finalized, presses the shutter key. The shutter key is one of the input keys 22. When the shutter key is pressed, the image data from the camera block 23 at that time is obtained. This image data is subjected to image processing by the image signal processing portion 25, and is compressed in for example the JPEG format by the image encoding/decoding portion 26. The compressed image data is placed into a file in for example the Exif format together with such supplementary information as the date of image capture, time of image capture, place of image capture, data type, camera model, shutter speed, aperture, focal length, image size, and ISO sensitivity, and is stored in the memory card 28.

At the time of playback, the desired image data is read from the memory card 28. As explained above, image data stored in the memory card 28 is compressed in for example JPEG format. Image data read from the memory card 28 is sent to the image encoding/decoding portion 26 and is decoded. This image data is then sent to the display portion 27, and is displayed on the display portion 27.

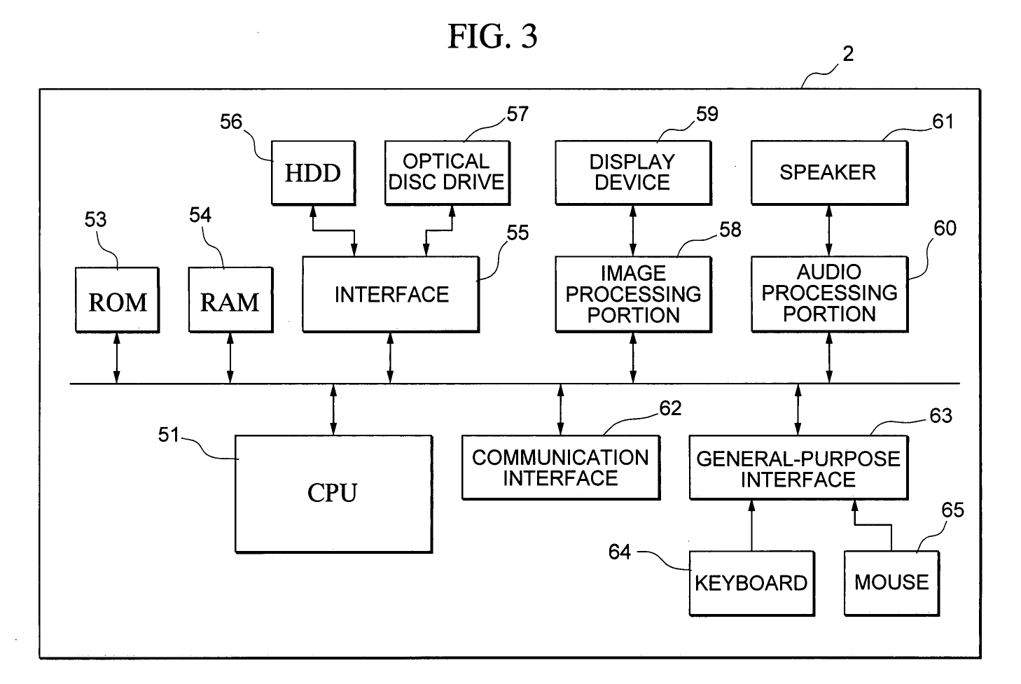

FIG. 3 shows the configuration of a data management device 2. The data management device 2 consists of a personal computer, on which is installed image management software.

In FIG. 3, the CPU (Central Processing Unit) 51 interprets and executes commands. The CPU 51 is connected to ROM (Read-Only Memory) 53 and to RAM (Random Access Memory) 54 via the bus 52. The ROM 53 stores the BIOS (Basic Input/Output System) and other boot programs. The RAM 54 is used as a work area.

The bus 52 is connected via the interface 55 to a HDD drive 56 and optical disc drive 57. Operating system programs and various application programs, together with various types of data, are stored on the HDD drive 56.

The bus 52 is connected to the display 59 via the image processing portion 58. A LCD (Liquid Crystal Display) or CRT (Cathode-Ray Tube) is used as the display 59. The bus 52 is connected, via the audio processing portion 60, to a speaker 61. The bus 52 is connected to a communication interface 62. The communication interface 62 is provided to enable communication with a LAN (Local Area Network), the Internet, or similar.

The bus 52 is further connected to a general-purpose interface 63. The general-purpose interface 63 may be, for example, a USB interface. The keyboard 64, mouse 65, and other input devices are connected to the general-purpose interface 63. This general-purpose interface 63 is also used to obtain image data from the digital camera 1. The general-purpose interface 63 is also used for connection to various other devices, such as a memory card drive or a printer.

Next, management of image files by an information management system to which a program of this invention has been applied is explained in detail.

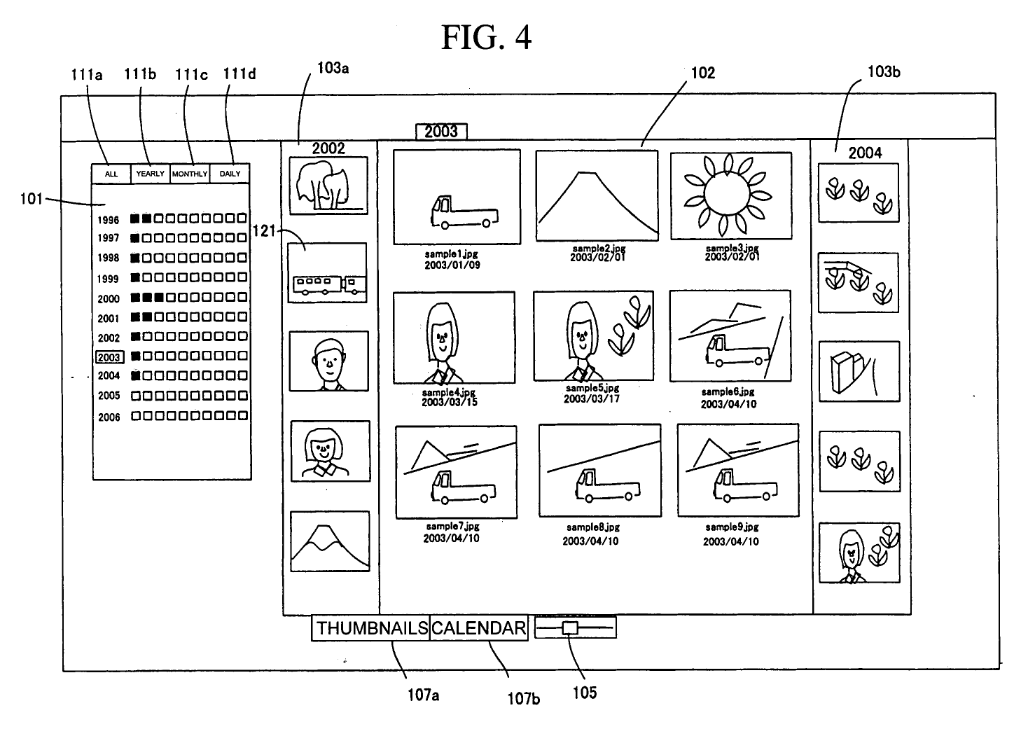

FIG. 4 shows a display screen of an information management program of this invention. As shown in FIG. 4, a tree area 101, thumbnail area 102, and sub-thumbnail areas 103a and 103b are displayed on the screen.

The tree area 101 displays classifications of stored images. In the upper part of the tree area 101 are provided the classification tags 111a, 111b, 111c, and 111d. By means of the classification tags 111a, 111b, 111c, and 111d, the periods “all”, “year”, “month”, and “day” can be switched when classifying images. Image files are managed with each of these “year”, “month” and “day” periods as groups.

FIG. 4 shows a case of the “yearly display mode” in which the “year” tag 111b is selected. When set to “yearly display mode”, a bar graph of the number of image files captured in each year is displayed in the tree area 101.

A list of thumbnail images of the images in a classification group selected in the tree area 101 is displayed in the thumbnail area 102. In this example, “2003” is selected in the tree area, and in the thumbnail area 102, a list of reduced-size images, called thumbnail images, of image files captured in 2003 are displayed as index images.

Thumbnail images of image files separated by a prescribed interval from the image files displayed in the thumbnail area 102 are extracted and displayed in the sub-thumbnail area 103a and in the sub-thumbnail area 103b. In the case of this embodiment, images from one year previous to, and one year following, the “year” displayed in the thumbnail area 102 are displayed in the sub-thumbnail areas 103a and 103b. For example, when images from “2003” are displayed in the thumbnail area 102, thumbnail images from “2002”, one year previous, are displayed in the sub-thumbnail area 103a, and thumbnail images from “2004”, one year later, are displayed in the sub-thumbnail area 103b. Aside from displaying images from one year before and one year after the “year” displayed in the thumbnail area 102, the sub-thumbnail areas 103a and 103b may display thumbnail images of images in periods a prescribed number of years before and after the images of the thumbnail area 102.

The thumbnail images displayed in the sub-thumbnail areas 103a and 103b are, compared with the thumbnail images displayed in the thumbnail area 102, made to be less prominent, and are not affected by image searches. Specifically, the thumbnail images displayed in the sub-thumbnail areas 103a and 103b are smaller than the thumbnail images displayed in the thumbnail area 102. In addition, the thumbnail images displayed in the sub-thumbnail areas 103a and 103b may be displayed with color saturation reduced and transparency increased compared with the thumbnail images displayed in the thumbnail area 102; or, the thumbnail images may be displayed with a combination of these attributes.

Below the thumbnail area 102 are provided a thumbnail selection tag 107a and a calendar selection tag 107b. The thumbnail selection tag 107a and calendar selection tag 107b are used to switch between thumbnail display and calendar display.

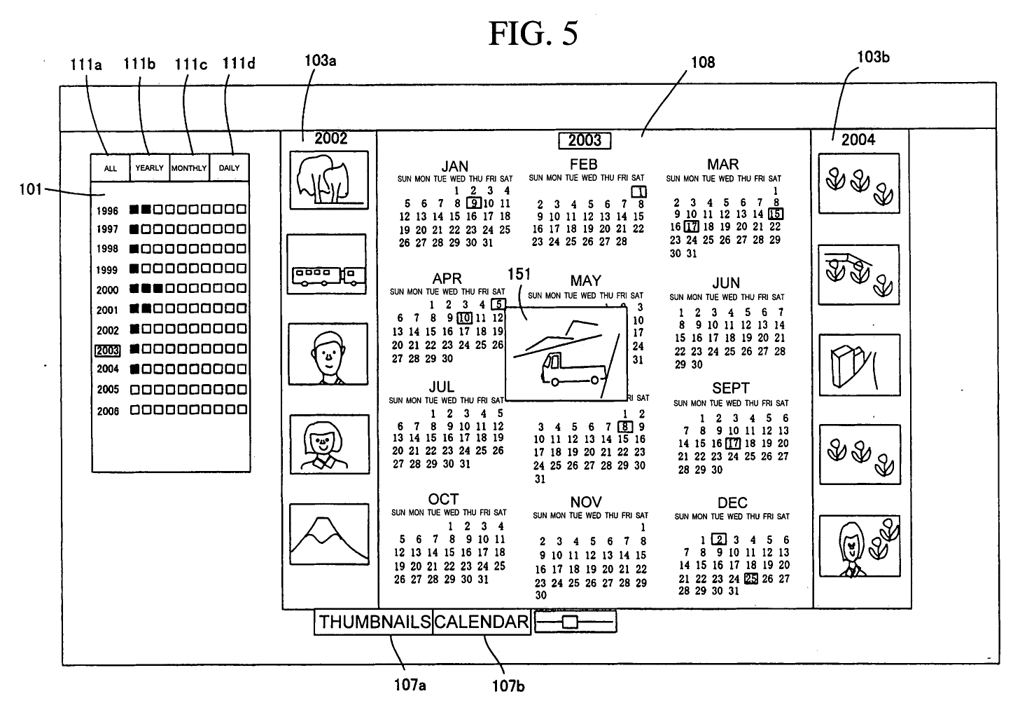

FIG. 5 shows a screen upon selecting the calendar selection tag 107b in FIG. 4 to switch to “calendar display mode”. In “calendar display mode”, the thumbnail area 102 becomes the calendar display area 108, and a calendar is displayed in the calendar display area 108. When the “year” tag 111b among the classification tags is selected, a mark (a surrounding square) is added to the dates for which there are image files. When the pointer is aligned with a date thus marked, a representative image among the images captured on that date is displayed. Similarly to FIG. 4, the sub-thumbnail area 103a and sub-thumbnail area 103b display thumbnail images of image files distant by a prescribed period from the image files displayed in the thumbnail area 102.

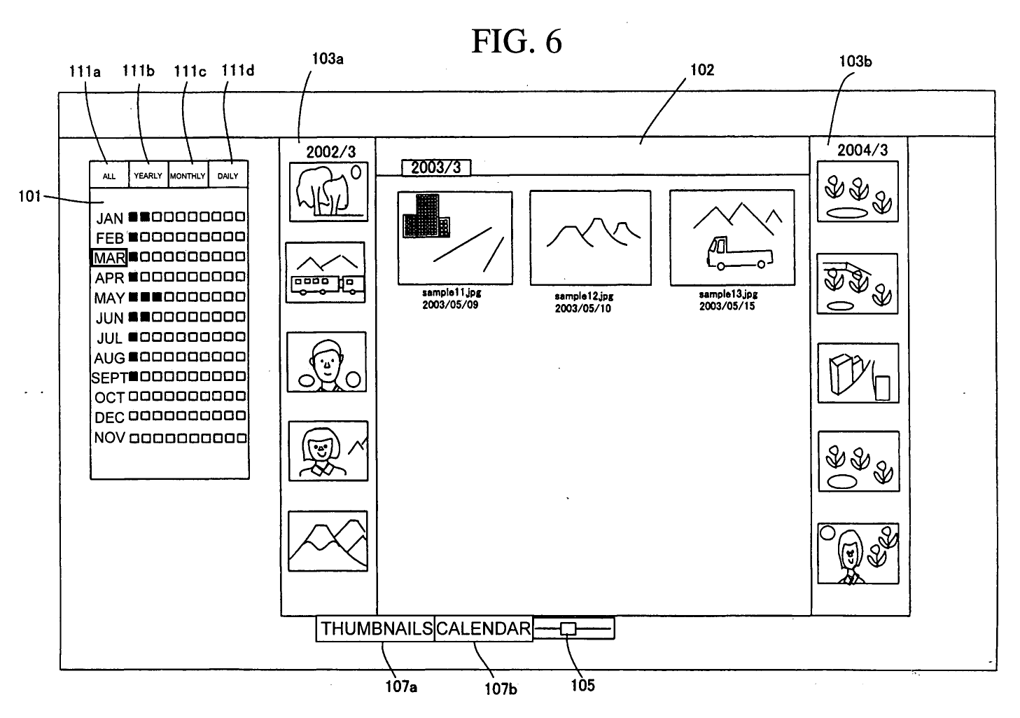

FIG. 6 shows an example of a screen when set to “thumbnail display mode” in “monthly display mode”. In this embodiment, images are displayed in the thumbnail area 102 for the month shown, and for the same month one year earlier and one year later. For example, when images for “March 2003” are displayed in the sub-thumbnail area 103b, thumbnail images for “March 2002” one year earlier are displayed in the sub-thumbnail area 103a, and thumbnail images for “March 2004” one year later are displayed in the sub-thumbnail area 103b.

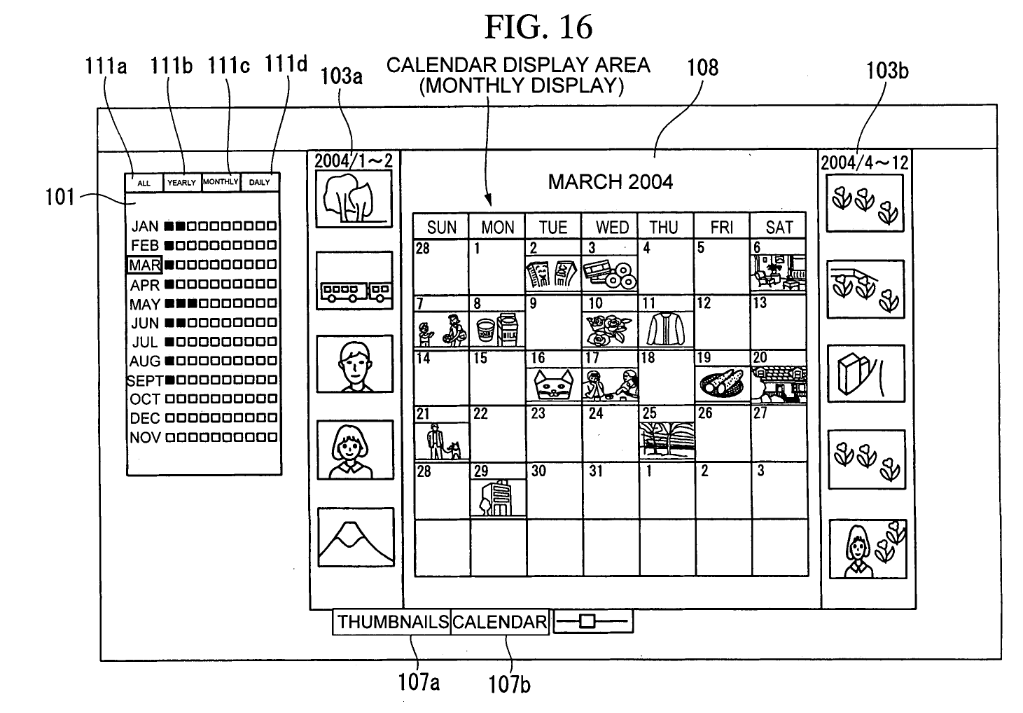

FIG. 16 shows an example of the screen display when set to “calendar display mode” in “monthly display mode”. In this embodiment, thumbnail images of representative images for each date are displayed in the enclosed area for each date in a one-month calendar, displayed in the calendar display area 108. Thumbnail images of images of the previous months in the same year of the calendar displayed in the calendar area 108 are displayed in the sub-thumbnail area 103a. On the other hand, thumbnail images of images from the following months in the same year as the calendar displayed in the calendar area 108 are displayed in the sub-thumbnail area 103b. As in the case of FIG. 6, the sub-thumbnail areas 103a and 103b may show thumbnail images of images in the same month as that displayed in the calendar area 108 for one year before and one year after. Alternatively, thumbnail images of images from all periods preceding the month displayed in the calendar area 108, and thumbnail images of images from all periods following the month displayed in the calendar area 108, may be displayed in the sub-thumbnail areas 103a and 103b, respectively.

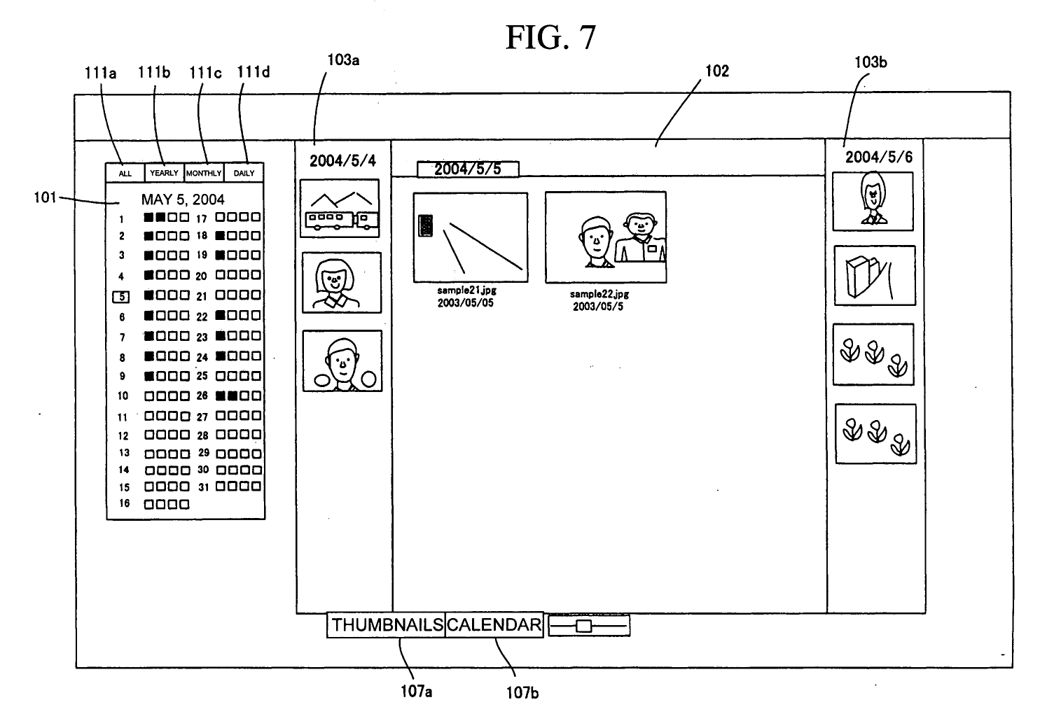

FIG. 7 shows a screen when set to “daily display mode”. When in “daily display mode”, images from one day before and from one day after the date displayed in the thumbnail area 102 are displayed in the sub-thumbnail areas 103a and 103b respectively. For example, when images for “May 5, 2004” are displayed in the thumbnail area 102, then thumbnail images for “May 4, 2004” or the day before are displayed in the sub-thumbnail area 103a, and thumbnail images for “May 6, 2004” or the day after are displayed in the sub-thumbnail area 103b. Thumbnail images of images for one week or for one month before and after, or for a prescribed number of days before and after the date displayed in the thumbnail area 102 may instead be displayed in the sub-thumbnail areas 103a and 103b, respectively.

Thus in an information management program to which this invention is applied, in addition to the thumbnail area 102 or calendar area 108, a sub-thumbnail area 103a and sub-thumbnail area 103b are provided, and thumbnail images of image files distant by a prescribed period from the image files displayed in the thumbnail area 102 are displayed in the sub-thumbnail area 103a and in the sub-thumbnail area 104b. By this means the user, while searching for desired image files, can encounter nostalgic images.

While searching for desired image files by viewing the thumbnail area 102 or the calendar area 108, the user can come upon nostalgic images while viewing the thumbnail images displayed in the sub-thumbnail areas 103a and 103b. When for example there is a thumbnail image which draws the user's attention in the sub-thumbnail area 103a, if the user selects this image from the sub-thumbnail area 103a, the group of images of the sub-thumbnail area 103a moves to the thumbnail area 102 or calendar area 108, and the group of images in the thumbnail area 102 or calendar area 108 moves to the sub-thumbnail area 103b. On the other hand, thumbnail images from images in a group one period before are displayed in the sub-thumbnail 103a. Similarly, when the user selects an image from the sub-thumbnail area 103b, the images in the group of the sub-thumbnail area 103b move to the thumbnail area 102 or calendar area 108, and the images in the group of the thumbnail area 102 or calendar area 108 move to the sub-thumbnail area 103a. Then, thumbnail images of images in the group one period previous are displayed in the sub-thumbnail area 103b.

For example, when thumbnail images of images belonging to the group “2003” are displayed in the thumbnail area 102 as shown in FIG. 4, thumbnail images of images belonging to the group “2002” are displayed in the sub-thumbnail area 103a, and thumbnail images of images belonging to the group “2004” are displayed in the sub-thumbnail area 103b.

Upon selecting an image 121 from the sub-thumbnail area 103a in FIG. 4, thumbnail images of images belonging to the group “2002” are displayed in the thumbnail area 102, and thumbnail images of images belonging to the group “2003” are displayed in the sub-thumbnail area 103b. Thumbnail images of images belonging to the group “2001” are displayed in the sub-thumbnail area 103a.

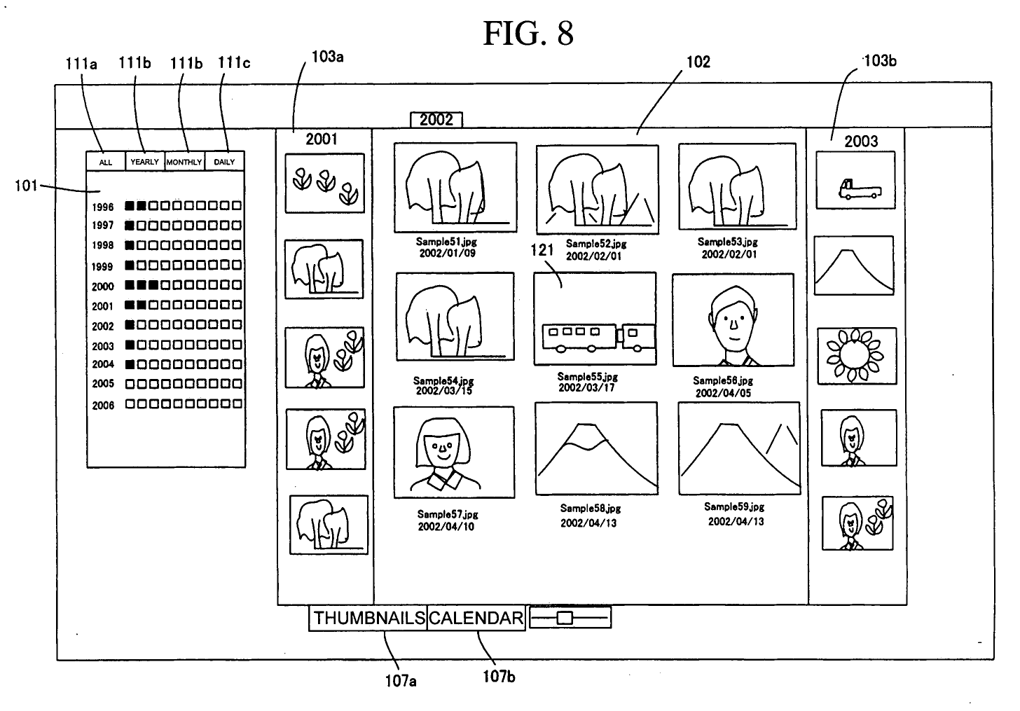

At this time, when the selected image 121 moves to the thumbnail area 102, images are always sorted so as to be displayed in the thumbnail area 102 as shown in FIG. 8. In this example, the selected image 121, upon moving into the thumbnail area 102, is moved so as to be substantially in the center of the thumbnail area 102.

That is, since the size of the thumbnail area 102 is limited, when there are numerous image files, not all files may fit into the area. When moving images to the thumbnail area 102, if the images are displayed in order in the thumbnail area 102, the selected image may not appear on the screen. In order to avoid such a situation, when images are moved to the thumbnail area 102, images are first sorted such that the selected image is always displayed in the thumbnail area. In this example, arrangements are made such that the selected image 121 is displayed in substantially the center of the thumbnail area 102 when images are moved to the thumbnail area 102; but the selected image may appear anywhere within the thumbnail area 102 on the screen. Also, rather than selecting a thumbnail image in a sub-thumbnail area, a sub-thumbnail area 103a or 103b may itself be selected, upon which the images in the group displayed in the selected sub-thumbnail area 103a or 103b are displayed in the thumbnail area 102 or in the calendar area 108. In this case, thumbnail images are displayed in the thumbnail area 102 in the order of display in the selected sub-thumbnail area 103a or 103b.

Because the sub-thumbnail areas 103a and 103b are provided for the display of images which are displayed in order to provide the user with an opportunity for fortuitous encounters with interesting images, there is no need to display the images belonging to such groups in order of date or name. In light of the aspect of fortuity, it is desirable that images be extracted randomly from among the images belonging to the group. Moreover, the sizes of the sub-thumbnail areas 103a and 103b are limited. Hence there are cases in which thumbnail images of all the images cannot be displayed in the sub-thumbnail areas 103a and 103b.

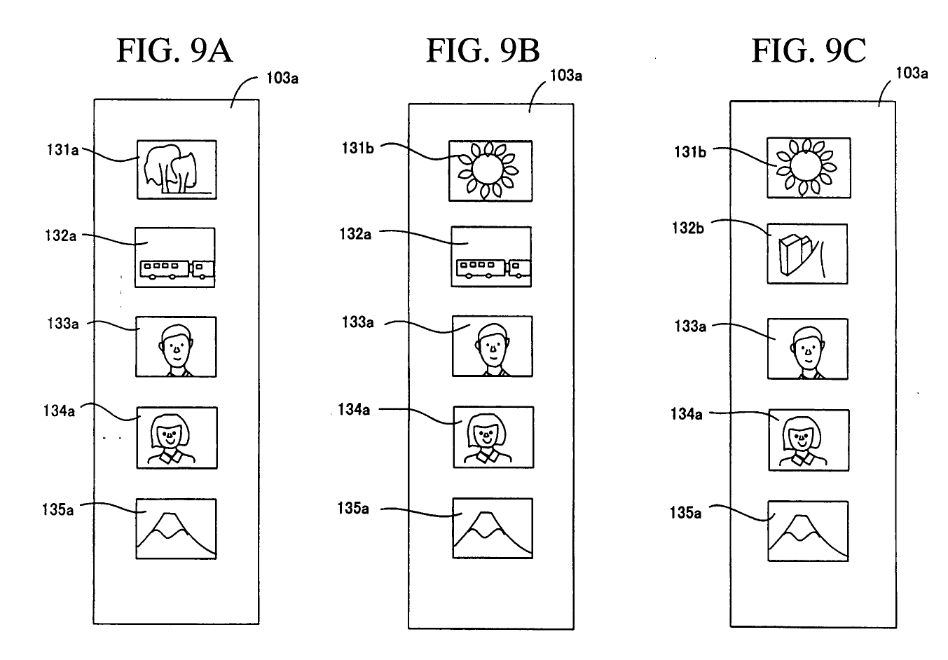

Hence as shown in FIG. 9A through FIG. 9C, when the number of images belonging to a group to be displayed in the sub-thumbnail areas 103a and 103b exceeds the number which can be displayed in the sub-thumbnail areas 103a and 103b, the thumbnail images to be displayed in the sub-thumbnail areas 103a and 103b are extracted at random from among the images belonging to these groups, and the images are updated automatically.

That is, as shown in FIG. 9A, the randomly extracted thumbnail images 131a, 132a, 133a, 134a, and 135a are displayed in the sub-thumbnail area 103a.

After a prescribed time has elapsed, the thumbnail image 131a in the sub-thumbnail area 103a is updated to the thumbnail image 131b, as shown in FIG. 9B. After a further prescribed time has elapsed, the thumbnail image 132a in the sub-thumbnail area 103a is updated to the thumbnail image 132b, as shown in FIG. 9C.

Subsequently, images displayed in the sub-thumbnail area 103a are updated in order with the passage of time. Similar processing is performed for the sub-thumbnail area 103b. The sub-thumbnail areas 103a and 103b are updated in order starting from the top of the screen; but any order of updating may be used.

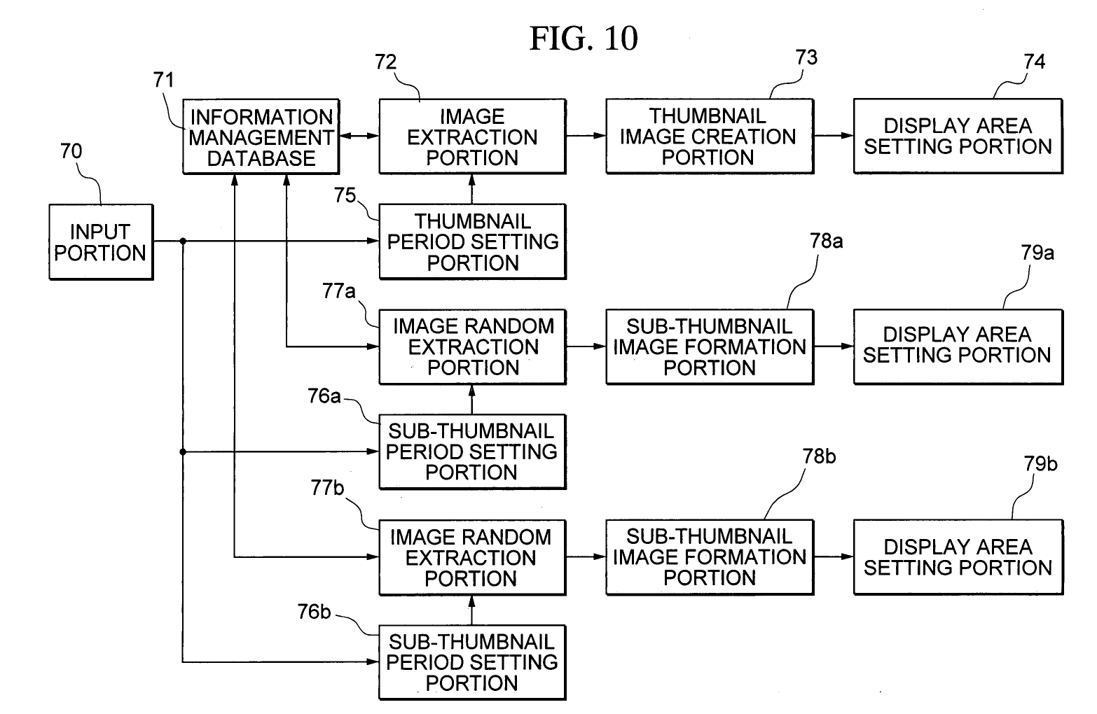

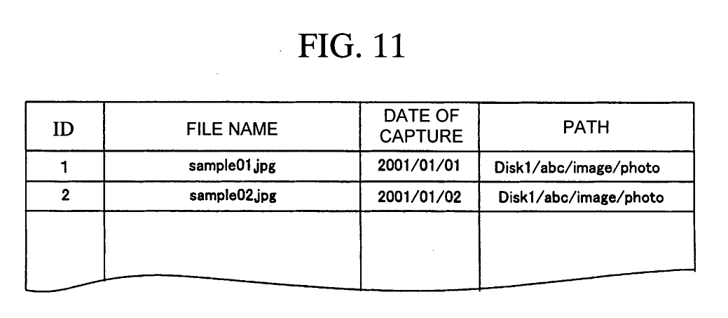

FIG. 10 employs a functional block diagram to represent operation to display images, as described above, in the thumbnail area 102 and in the sub-thumbnail areas 103a and 103b. As indicated in FIG. 11, for each image a file ID, file name, date of image capture, and file storage path are registered, in association, in the information management database 71 shown in FIG. 10. This information management database 71 is created based for example on image files in the Exif format when image data is transferred from the digital camera 1. Fields such as “time of image capture”, “place of image capture”, “data type”, “camera model”, “shutter speed”, “aperture”, “focal length”, “image size”, “ISO sensitivity”, and “photographer” may also be provided in the information management database 71.

Specification information is input to the input portion 70. When the specification information is input to the input portion 70, the period for the group to be displayed in the thumbnail area 102 is set by the thumbnail area period setting portion 75. Prescribed group information is extracted from the information management database 71 by the image extraction portion 72, based on the specification information. For example, when as the specification information the “2003” group is specified in yearly display mode, image information with an image capture date of “2003” is extracted from the information management database 71. The extracted image information is sent to the thumbnail image creation portion 73. Thumbnail images to be displayed in the thumbnail area 102 are formed in the thumbnail image formation portion 73.

When the specification information is input to the input portion 70, the period for the group to be displayed in the sub-thumbnail area 103a is set by the sub-thumbnail area period setting portion 76a. Information for the prescribed group is extracted at random from the information management database 71 by the image random extraction portion 77a, based on this specification information.

For example, when the group “2003” is specified in the yearly mode as search information, the sub-thumbnail area period setting portion 76a sets the group “2002” of the previous year. Then, image information for the “2002” group is extracted at random from the information management database 71 by the image random extraction portion 77a. The extracted image information is sent to the sub-thumbnail image formation portion 78a. Thumbnail images to be displayed in the sub-thumbnail area 103a are then formed by the sub-thumbnail image formation portion 78a.

Similarly, when specification information is input to the input portion 70, the period for the group to be displayed in the sub-thumbnail area 103b is set by the sub-thumbnail area period setting portion 76b. Based on this specification information, information for the prescribed group is extracted from the information management database 71.

For example, when the group “2003” is specified in yearly mode as the search information, the sub-thumbnail area period setting portion 76b specifies the group “2004” of the following year. And, the image random extraction portion 77b randomly extracts image information belonging to, for example, the group “2004” from the information management database 71. The extracted image information is sent to the sub-thumbnail image formation portion 78b. Thumbnail images to be displayed in the sub-thumbnail area 103b are formed in the sub-thumbnail image formation portion 78b.

The information for thumbnail images formed by the thumbnail image formation portion 73 is sent to the display area setting portion 74. Information for thumbnail images formed by the sub-thumbnail image formation portion 78a and 78b is sent to the display area setting portions 79a and 79b. By this means, when for example the group “2003” is input in yearly mode as the search information, thumbnail images belonging to the group “2003” are displayed in the thumbnail area 102, and thumbnail images belonging to the groups “2002” and “2004” are extracted at random and displayed in the sub-thumbnail areas 103a and 103b respectively.

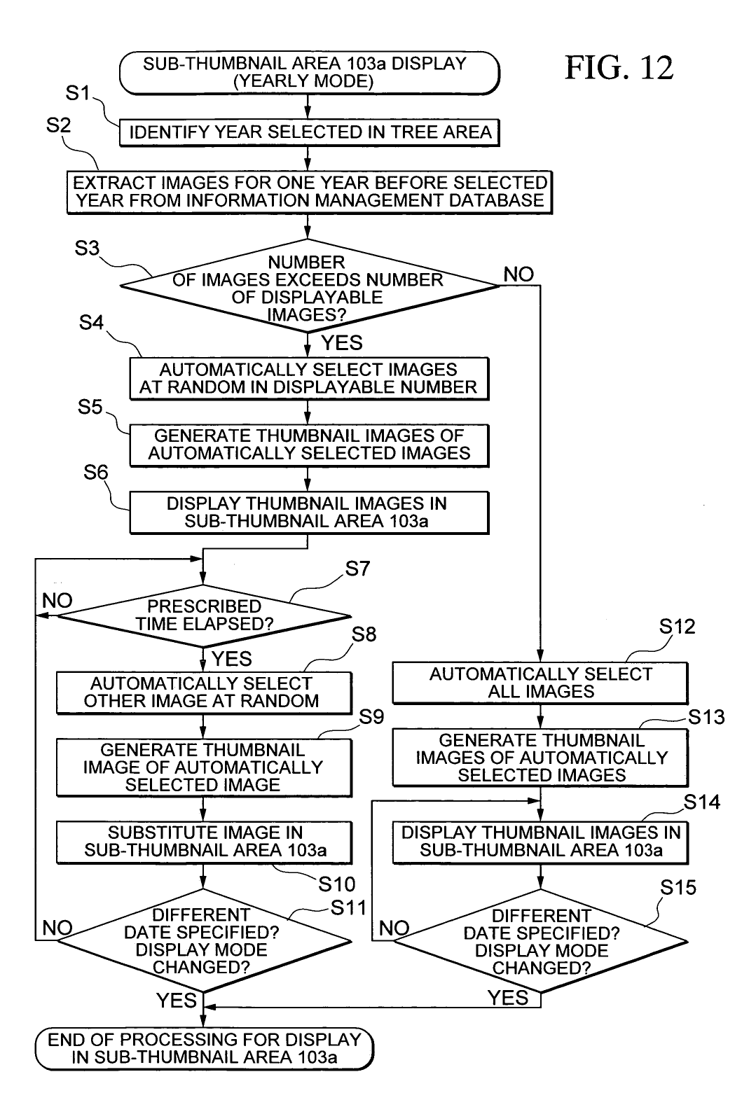

FIG. 12 is a flowchart showing processing for displaying images in the sub-thumbnail area 103a in yearly mode.

In the tree area 101 of FIG. 4, the selected year is identified (step S1), and image information for the year before the selected year is extracted from the information management database (FIG. 11) (step S2). A judgment is made as to whether the number of extracted images exceeds the number of images which can be displayed in the sub-thumbnail area 103a (step S3), and if the number of displayable images is exceeded, images in the number which can fit in the sub-thumbnail area 103a are automatically selected at random (step S4). Then, thumbnail images of the selected images are generated (step S5), and these thumbnail images are displayed in the sub-thumbnail area 103a (step S6). Thumbnail images in the sub-thumbnail area 103a are set to a smaller size (for example, 80×60 pixels) than the thumbnail images to be displayed in the thumbnail area, with the transparency set to 50%.

After thumbnail images have been displayed in the sub-thumbnail area 103a, a judgment is made as to whether a prescribed time has elapsed (step S7), and if the prescribed time has elapsed, an image other than the images displayed thus far is automatically selected at random (step S8), a thumbnail image of the selected image is generated (step S9), and this thumbnail image is substituted for and displayed in the place of a thumbnail image displayed up to this time in the sub-thumbnail area 103a (step S10). During substitution of the thumbnail image, cross-fading or other transition effects may be used. A judgment is made as to whether a different date has been specified or the display mode has been changed (step S11), and if there has been no change, processing returns to step S7.

When a different date has been specified, or when the display mode has been changed, processing for display in sub-thumbnail area 103a ends. Thus when image information for the year before the specified year exceeds the displayable area of the sub-thumbnail area 103a, by repeating steps S7 through S11, images are substituted randomly in the sub-thumbnail area 103a.

In step S3, when the number of extracted images does not exceed the number of images displayable in the sub-thumbnail area 103a, all the images extracted in step S2 are selected (step S12), thumbnail images of the selected images are generated (step S13), and these thumbnail images are displayed in the sub-thumbnail area 103a (step S14).

Next, a judgment is made as to whether a different date has been specified and whether the display mode has been changed (step S15), and if a change has not been made, processing returns to step S14. When a different date has been specified or the display mode has been changed, display processing for the sub-thumbnail area 103a ends.

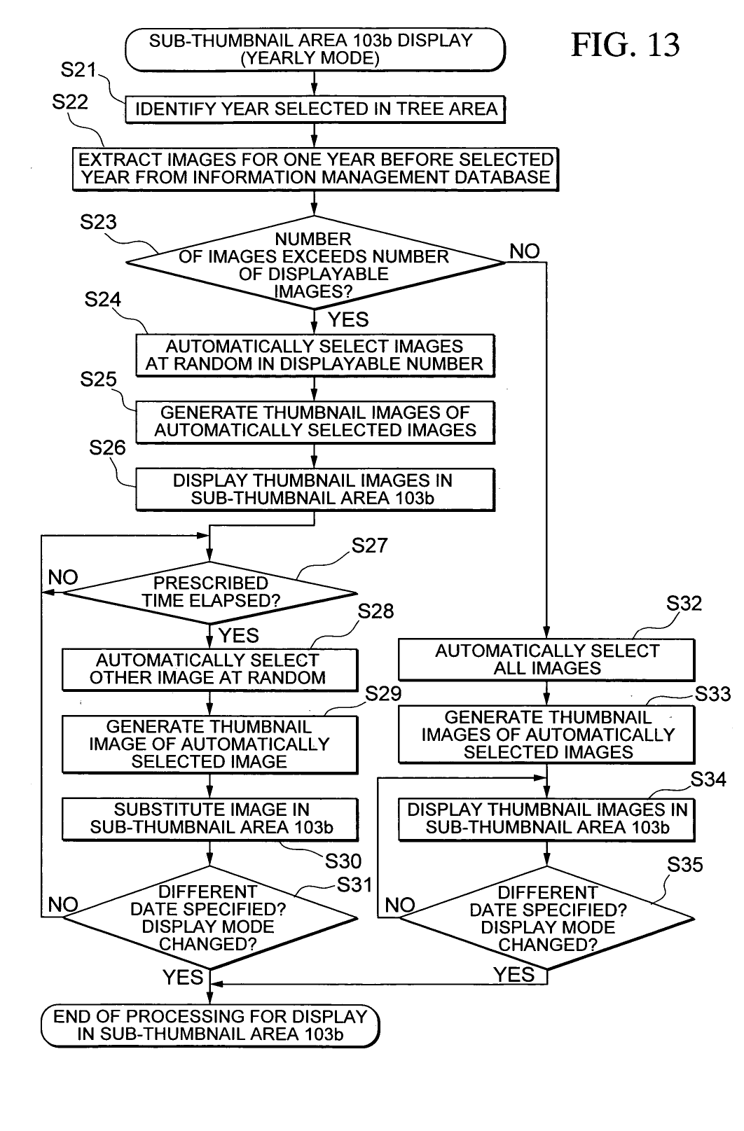

FIG. 13 is a flowchart showing processing for display in the sub-thumbnail area 103b in yearly mode.

The year selected in the tree area 101 in FIG. 4 is identified (step S21), and image information for the year following the selected hear is extracted from the information management database (FIG. 11) (step S22). A judgment is made as to whether the number of extracted images exceeds the number of images displayable in the sub-thumbnail area 103b (step S23), and if the number of displayable images is exceeded, a number of images which fit in the sub-thumbnail area 103b are automatically selected at random (step S24). Next, thumbnail images of the selected images are generated (step S25), and these thumbnail images are displayed in the sub-thumbnail area 103b (step S26). The thumbnail images in the sub-thumbnail area 103b are set to a size smaller than that of the thumbnail images displayed in the thumbnail area (for example, 80×60 pixels), and to 50% transparency.

When the thumbnail images are displayed in the sub-thumbnail area 103b, a judgment is made as to whether a prescribed time has elapsed (step S27), and when the prescribed time has elapsed, images other than the images displayed up until that time are automatically selected at random (step S28), thumbnail images of the selected images are generated (step S29), and the thumbnail images are substituted for and displayed instead of the thumbnail images displayed in the sub-thumbnail area 103b up until that time (step S30). When substituting thumbnail images, cross-fading or other transition effects may be used. Next, a judgment is made as to whether a different date has been specified or the display mode has been changed (step S31), and if there has been no change, processing returns to step S27. If a different date has been specified or the display mode has been changed, display processing for the sub-thumbnail area 103b ends. Thus when the number of images for the year before the specified year exceeds the number of images displayable in the sub-thumbnail 103b, by repeating the steps S27 to S31, images are randomly substituted in the sub-thumbnail area 103b.

In step S23, if the number of extracted images does not exceed the number of images displayable in the sub-thumbnail area 103b, then all the images extracted in step S22 are selected (step S32), thumbnail images of the selected images are generated (step S33), and these thumbnail images are displayed in the sub-thumbnail area 103b (step S34). Next, a judgment is made as to whether a different date has been specified or the display mode has been changed (step S35), and if there has been no change, processing returns to step S34. If a different date has been specified, or if the display mode has been changed, processing to display images in the sub-thumbnail area 103b ends.

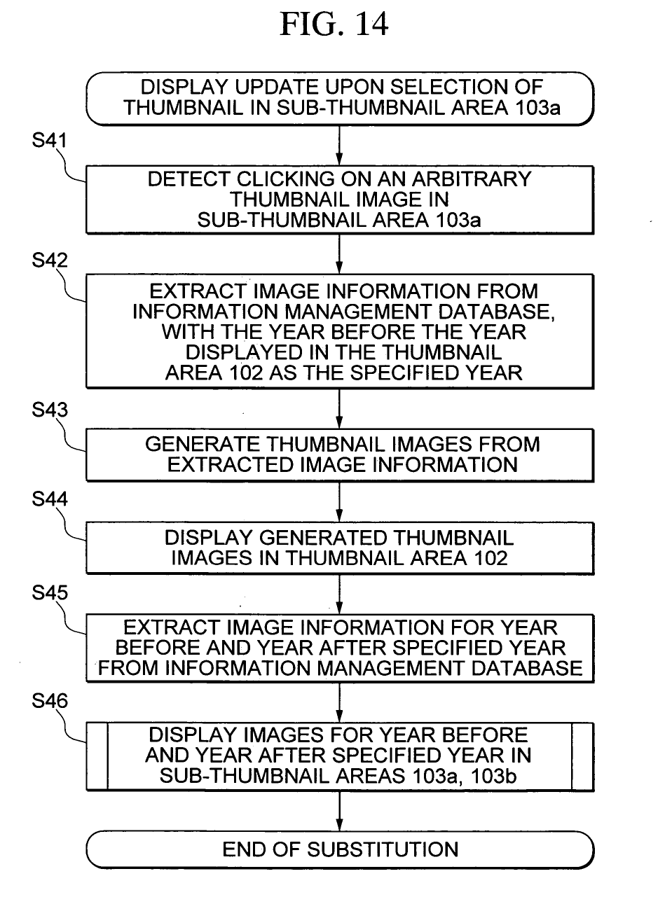

FIG. 14 is a flowchart showing processing when thumbnail images for the sub-thumbnail area 103a are selected in yearly mode, and the display in the thumbnail area 102 and sub-thumbnail areas 103a and 103b is updated.

When clicking of an image in the sub-thumbnail area 103a shown in FIG. 4 is detected (step S41), this event is regarded as specification of the year before the year of the images displayed in the thumbnail area 102, and so image information for the year specified is extracted from the information management database (step S42). Next, thumbnail images of the extracted images are generated (step S43), and these thumbnail images are displayed in the thumbnail area 102 (step S44).

Image information for the year before, and image information for the year after, the year regarded as having been specified is extracted from the information management database (step S45), and the extracted images are used to display thumbnail images in the sub-thumbnail area 103a and in the sub-thumbnail area 103b (step S46). As indicated in the above-described flowcharts of FIG. 12 and FIG. 13, when the number of images exceeds the number of images displayable in the sub-thumbnail areas 103a and 103b, the images are updated randomly.

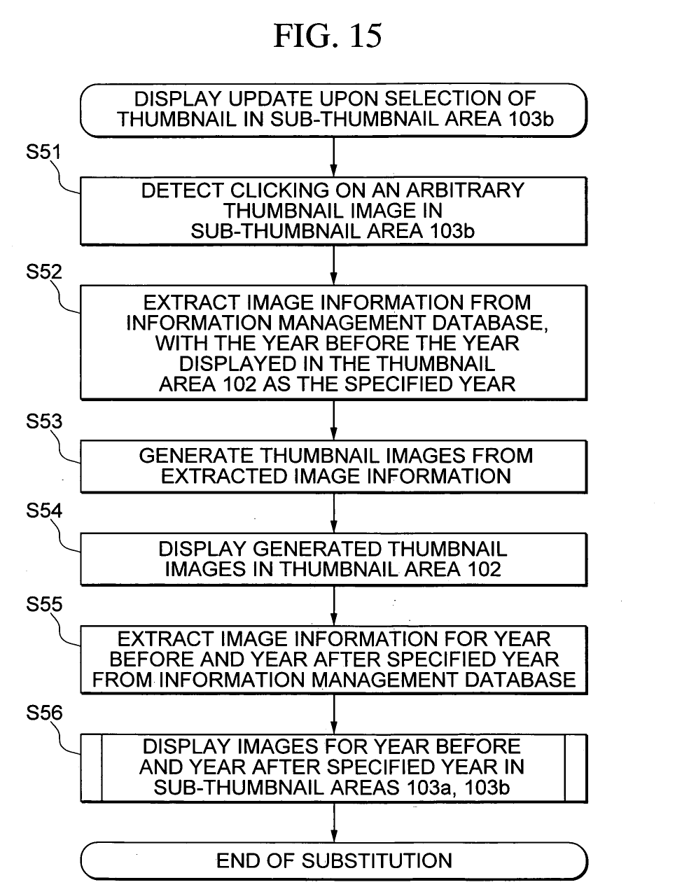

FIG. 15 is a flowchart showing processing in which a thumbnail image in the sub-thumbnail area 103b is selected in yearly mode, and the images displayed in the thumbnail area 102 and in the sub-thumbnail areas 103a and 103b are updated.

When clicking of an image in the sub-thumbnail area 103b shown in FIG. 4 is detected (step S51), this event is regarded as specification of the year after the year of the images displayed in the thumbnail area 102, and so image information for the year specified is extracted from the information management database (step S52). Next, thumbnail images of the extracted images are generated (step S53), and these thumbnail images are displayed in the thumbnail area 102 (step S54).

Image information for the year before, and image information for the year after, the year regarded as having been specified is extracted from the information management database (step S55), and the extracted images are used to display thumbnail images in the sub-thumbnail area 103a and in the sub-thumbnail area 103b (step S56). As indicated in the above-described flowcharts of FIG. 12 and FIG. 13, when the number of images exceeds the number of images displayable in the sub-thumbnail areas 103a and 103b, the images are updated randomly.

As explained above, in this invention sub-thumbnail areas 103a and 103b are provided in addition to a thumbnail area 102, and thumbnail images of images from, for example, one year before and from one year after the images displayed in the thumbnail area are displayed randomly in the sub-thumbnail areas 103a and 103b. Consequently in addition to the images resulting from a search specified by the user, the user can encounter unanticipated images, presenting the user with chance encounters with images, and inducing retrospection and a desire to use the images.

This invention is not limited to the above-described embodiments, but can be variously modified without deviating from the gist of the invention.

For example, in the above-described examples, when in yearly display mode, thumbnail images from groups one year earlier than and one year later than the images in the thumbnail area 102 are displayed in the sub-thumbnail areas 103a and 103b; but other images may be displayed. For example, thumbnail images from two years earlier and two years later, or from three years earlier and three years later, than the images in the thumbnail area 102 may be displayed in the sub-thumbnail areas 103a and 103b.

Similarly in the above-described examples, when in daily display mode, thumbnail images from groups one day earlier than and one year later than the images in the thumbnail area 102 are displayed in the sub-thumbnail areas 103a and 103b; but other images may be displayed. For example, thumbnail images from two days earlier and two days later, or from three days earlier and three days later, than the images in the thumbnail area 102 may be displayed in the sub-thumbnail areas 103a and 103b.

In the above-described examples, when in monthly display mode, an example in which thumbnail images from groups in the same month of the preceding year and of the following year of the images in the thumbnail area 102 are displayed in the sub-thumbnail areas 103a and 103b, and an example in which thumbnail images from the groups of all months preceding and thumbnail images from the groups of all months following the calendar displayed in the calendar area 108, and in the same year as the calendar, are displayed in the sub-thumbnail areas 103a and 103b, are explained. However, other images may be displayed. For example, thumbnail images from one month before and from one month after the thumbnail area 102 or calendar area 108 may be displayed in the sub-thumbnail areas 103a and 103b. Further, thumbnail images from two months before and from two months after, or from three months before and three months after, the thumbnail area 102 and calendar area 108, may be displayed in the sub-thumbnail areas 103a and 103b.

Further, in the above-described examples the two sub-thumbnail areas 103a and 103b are provided adjacent to and on the left and right of the thumbnail area 102; but the two sub-thumbnail areas 103a and 103b may be provided above and below the thumbnail area 102.

Further, in the above-described examples two sub-thumbnail areas 103a and 103b are provided; but only a single sub-thumbnail area may be provided.

Further, four sub-thumbnail areas may be provided, above and below, and to the left and right of, the thumbnail area 102.

This invention is configured as software installed as a program for image management, but may similarly be configured as hardware. Moreover, similar image management functions may be incorporated into a digital camera.

This invention is suitable for the management of image files captured using a digital camera and transferred to a personal computer.

According to this invention, a thumbnail area in which are displayed index images of images belonging to a group selected by the user (first display area), and a sub-thumbnail area in which are displayed images different from the images of the index area, and automatically selected at random (second display area), are provided. Thumbnail images of images belonging to a group distant by a prescribed period from the group displayed in the index area are extracted at random and displayed in the sub-thumbnail area. For example, when classifying images by year of image capture, images captured the year before or the year after the images displayed in the thumbnail area are extracted at random and displayed in the sub-thumbnail area.

In this way, in addition to the images resulting from a search specified by the user, images not anticipated by the user are also displayed on the same screen, presenting the user with chance encounters with images.

What is claimed is:

1. An image display device which displays a plurality of images, comprising:
a classification unit which classifies a plurality of images into a plurality of groups by period based on date information accompanying each image;
a group selection unit which selects one group classified by said classification unit corresponding to a date specified by the user;
a screen division unit which divides said display screen into a plurality of display areas;
a first display unit which displays index images of images belonging to a first group selected by said group selection unit in a first display area of the screen divided by said screen division unit; and
a second display unit which displays index images of images belonging to one or a plurality of second groups different from said first group in one or a plurality of respective second display areas different from said first display area.

2. The image display device according to claim 1, wherein said classification unit classifies said plurality of images into groups by the year of image capture or by the month of image capture or by the day of image capture, and said group selection unit selects said groups with the year of image capture or the month of image capture or the day of image capture selected by the user.

3. The image display device according to claim 2, wherein the number of second display areas displayed by said second display unit is two, and the period of image capture of images of the second groups displayed in said second display areas are distant by a prescribed period from the period of image capture of the images of the first group selected by said group selection unit.

4. The image display device according to claim 3, wherein said second display areas are positioned adjacent to and on both sides of said first display area, and each display index images of images captured during periods adjacent to the period of image capture of the images of the first group.

5. The image display device according to claim 4, wherein index images displayed in said first display area correspond to a year of image capture or month of image capture or day of image capture specified by said user, and index images displayed in said second display areas correspond to images belonging to groups the image capture date of which is the year before or after, or the month before or after, or the day before or after, said specified image capture year, month or day.

6. The image display device according to claim 2, further comprising:
a calendar display unit which displays a calendar in said first display area; and
an image positioning unit which positions index images of images in said first group in each of the date areas of the calendar displayed in said first display area corresponding to the respective dates of image capture.

7. The image display device according to claim 2, wherein index images displayed in said second display area are displayed at smaller size, or with lower color saturation, or with higher transparency, than the index images displayed in said first display area.

8. The image display device according to claim 3, further comprising:
a display area selection unit which selects said second display areas; and
a display update unit which updates groups displayed in each of said display areas such that a group being displayed in a second display area which has been selected by said display area selection unit is displayed in said first display area.

9. The image display device according to claim 8, further comprising a thumbnail selection unit which selects thumbnail images displayed in said second display areas, and wherein said display update unit updates groups displayed in each display area such that the group comprising a thumbnail image selected by said thumbnail selection unit is displayed in said first display area, and images comprised by the group displayed in said first display area are sorted such that the thumbnail image selected by said thumbnail selection unit is displayed in said first display area.

10. The image display device according to claim 2, further comprising an index image substitution unit which automatically substitutes index images of images not displayed for index images which are displayed when displaying a group having a number of members exceeding the number of index images which can be displayed at one time in said second display area.

11. The image display device according to claim 3, wherein index images displayed in said first display area correspond to images captured in a month specified by said user, and index images displayed in said second display areas correspond to images captured in the same month of the year before and the year after, respectively, said specified image capture month.

12. The image display device according to claim 3, wherein index images displayed in said first display area correspond to images captured on a day specified by said user, and index images displayed in said second display areas correspond to images captured on the same day of the year before and the year after, respectively, said specified image capture day.

13. An image display program to display a plurality of images, comprising:
a classification step of classifying a plurality of images into a plurality of groups by period based on date information accompanying each image;
a group selection step of selecting one group classified in said classification step corresponding to a date specified by a user;
a screen division step of dividing said display screen into a plurality of display areas;
a first display step of displaying index images of images belonging to a first group selected in said group selection step in a first display area of the screen divided in said screen division step; and
a second display step of displaying index images of images belonging to one or a plurality of second groups different from said first group in one or a plurality of respective second display areas different from said first display area.

14. The image display program according to claim 13, wherein said plurality of images are classified into groups by the year of image capture or by the month of image capture or by the day of image capture in said classification step, and said group is selected to have the year of image capture or the month of image capture or the day of image capture selected by the user in said group selection step.

15. The image display program according to claim 14, wherein the number of display areas in which images are displayed in said second display step is two, and the periods of capture of images in said second groups displayed in said second display area are distant by a prescribed period from the period of image capture of images in said first group selected in said group selection step.

16. The image display program according to claim 15, wherein said second display areas are positioned adjacent to and on either side of said first display area, and respectively display images corresponding to periods adjacent to the period of capture of images of said first group.

17. The image display program according to claim 16, wherein index images displayed in said first display area correspond to images of an image capture year or an image capture month or an image capture day specified by said user, and index images displayed in said second display areas correspond to images belonging to groups the image capture date of which is the year before or after, or the month before or after, or the day before or after, said specified image capture year, month or day.

18. The image display program according to claim 14, further comprising:
a calendar display step of displaying a calendar in said first display area; and
an image positioning step of positioning index images of images in said first group in each of the date areas of the calendar displayed in said first display area corresponding to the respective dates of image capture.

19. The image display program according to claim 14, wherein index images displayed in said second display area are displayed at smaller size, or with lower color saturation, or with higher transparency, than the index images displayed in said first display area.

20. The image display program according to claim 15, further comprising:
a display area selection step of selecting said second display areas; and
a display update step of updating groups displayed in each of said display areas such that a group being displayed in a second display area which has been selected by said display area selection unit is displayed in said first display area.

21. The image display program according to claim 20, further comprising a thumbnail selection step of selecting a thumbnail image displayed in said second display area, and wherein said display update step updates groups displayed in each display area such that the group comprising a thumbnail image selected in said thumbnail selection step is displayed in said first display area, and images comprised by the group displayed in said first display area are sorted such that the thumbnail image selected in said thumbnail selection step is displayed in said first display area.

22. The image display program according to claim 14, further comprising an index substitution step of automatically substituting index images of images not displayed for index images which are displayed when displaying a group having a number of members exceeding the number of index images which can be displayed at one time in said second display area.

23. The image display program according to claim 15, wherein index images displayed in said first display area correspond to images captured in a month specified by said user, and index images displayed in said second display areas correspond to images captured in the same month of the year before and the year after, respectively, said specified image capture month.

24. The image display program according to claim 15, wherein index images displayed in said first display area correspond to images captured on a day specified by said user, and index images displayed in said second display areas correspond to images captured on the same day of the year before and the year after, respectively, said specified image capture day.

25. Computer-readable recording media on which is recorded an image display program to display a plurality of images, said display program comprising:
a classification step of classifying a plurality of images into a plurality of groups by period based on date information accompanying each image;
a group selection step of selecting one group classified in said classification step corresponding to a date specified by a user;
a screen division step of dividing said display screen into a plurality of display areas;
a first display step of displaying index images of images belonging to a first group selected in said group selection step in a first display area of the screen divided in said screen division step; and
a second display step of displaying index images of images belonging to one or a plurality of second groups different from said first group in one or a plurality of respective second display areas different from said first display area.

26. The recording media according to claim 25, wherein in said classification step said plurality of images are classified into groups by the year of image capture or by the month of image capture or by the day of image capture, and in said group selection step said group is selected to have the year of image capture or the month of image capture or the day of image capture selected by the user.

27. The recording media according to claim 26, wherein the number of display areas in which images are displayed in said second display step is two, and the periods of capture of images in said second groups displayed in said second display area are distant by a prescribed period from the period of image capture of images in said first group selected in said group selection step.

28. The recording media according to claim 27, wherein said second display areas are positioned adjacent to and on either side of said first display area, and respectively display images corresponding to periods adjacent to the period of capture of images of said first group.

29. The recording media according to claim 28, wherein index images displayed in said first display area correspond to images of an image capture year or an image capture month or an image capture day specified by said user, and index images displayed in said second display areas correspond to images belonging to groups the image capture date of which is the year before or after, or the month before or after, or the day before or after, said specified image capture year, month or day.

30. The recording media according to claim 26, further comprising:
a calendar display step of displaying a calendar in said first display area; and
an image positioning step of positioning index images of images in said first group in each of the date areas of the calendar displayed in said first display area corresponding to the respective dates of image capture.

31. The recording media according to claim 26, wherein index images displayed in said second display area are displayed at smaller size, or with lower color saturation, or with higher transparency, than the index images displayed in said first display area.

32. The recording media according to claim 27, further comprising:
a display area selection step of selecting said second display areas; and
a display update step of updating groups displayed in each of said display areas such that a group being displayed in a second display area which has been selected by said display area selection unit is displayed in said first display area.

33. The recording media according to claim 32, further comprising a thumbnail selection step of selecting a thumbnail image displayed in said second display area, and wherein said display update step updates groups displayed in each display area such that the group comprising a thumbnail image selected in said thumbnail selection step is displayed in said first display area, and images comprised by the group displayed in said first display area are sorted such that the thumbnail image selected in said thumbnail selection step is displayed in said first display area.

34. The recording media according to claim 26, further comprising an index substitution step of automatically substituting index images of images not displayed for index images which are displayed when displaying a group having a number of members exceeding the number of index images which can be displayed at one time in said second display area.

35. The recording media according to claim 27, wherein index images displayed in said first display area correspond to images captured in a month specified by said user, and index images displayed in said second display areas correspond to images captured in the same month of the year before and the year after, respectively, said specified image capture month.

36. The recording media according to claim 27, wherein index images displayed in said first display area correspond to images captured on a day specified by said user, and index images displayed in said second display areas correspond to images captured on the same day of the year before and the year after, respectively, said specified image capture day.
